(19) United States
(12) Patent Application Publication
(10) Pub. No.: US 2021/0285279 A1
(43) Pub. Date: Sep. 16, 2021

(54) SHUTTER WITH DIMMING CAPABILITY

(71) Applicants: JIANMING ZHAO, Shouguang City (CN); TAIWAN BAMBOO CURTAIN ENTERPRISE CO., LTD., Lugang Township (TW)

(72) Inventors: Yang-Hsin Shih, Fuxing Township (TW); Chin-Chang Shih, Lukang Township (TW)

(21) Appl. No.: 16/820,672

(22) Filed: Mar. 16, 2020

(51) Int. Cl. E06B 9/02

(52) U.S. Cl. CPC E06B 9/02

(57) ABSTRACT

A shutter with a dimming capability has a frame member, a first shutter body, and a second shutter body. The first shutter body has a plurality of through apertures on a surface and at least one magnetic member disposed along two sides of the through apertures. A height of the second shutter body is shorter than a height of the first shutter body, and the second shutter body further has a plurality of horizontal channels on a surface and at least one magnet member disposed along the horizontal channels. An area of the magnet member is smaller than an area of the magnetic member. The first and second shutter bodies are combinable via the magnetic member and the magnet member and slidably mounted in the frame member such that the second shutter body is movable in the frame member.

### BACKGROUND of INVENTION

### Field of Invention

The present invention relates to a shading structure, and more particularly to a shutter with dimming capability.

### Description of the Related Art

Windows are usually set up in homes and workplaces as a structure to provide outdoor air and light into indoors, and most windows will be equipped with curtains or blinds for shielding, adjusting or blocking light from penetrating the window to achieve the adjustment of indoor light transmittance.

However, curtains and blinds can only be applied to the window frame structure not skyline or lighting fixture.

Therefore, it is desirable to provide a shutter with dimming capability to mitigate and/or obviate the aforementioned problems.

### SUMMARY OF THE INVENTION

An objective of present invention is to provide a shutter with dimming capability, which is capable of improving the above-mention problems.

In order to achieve the above mentioned objective, a shutter with a dimming capability has a frame member, a first shutter body, and a second shutter body. The first shutter body has a plurality of through apertures on a surface and at least one magnetic member disposed along two sides of the through apertures. A height 5 of the second shutter body is shorter than a height of the first shutter body, and the second shutter body further has a plurality of horizontal channels on a surface and at least one magnet member disposed along the horizontal channels. An area of the magnet member is smaller than an area of the magnetic member. The first and second shutter bodies are combinable via the magnetic member and the magnet 10 member and slidably mounted in the frame member such that the second shutter body is movable in the frame member.

Other objects, advantages, and novel features of invention will become more apparent from the following detailed description when taken in conjunction with the accompanying drawings.

### BRIEF DESCRIPTION OF DRAWINGS

FIG. 1 is a three-dimensional view of a preferred embodiment according to the present invention.

FIG. 2 is an exploded view of the installation of the screen net of the preferred embodiment according to the present invention.

FIG. 3: This is an exploded view of the preferred embodiment according to the present invention.

FIG. 4: This is a front view of the preferred embodiment according to the present invention.

FIG. 5 shows a cross-sectional view of completely open state along line A-A and B-B in FIG. 3 of the preferred embodiment according to the present invention.

FIG. 6 shows a cross-sectional view of dimed state along line A-A and B-B in

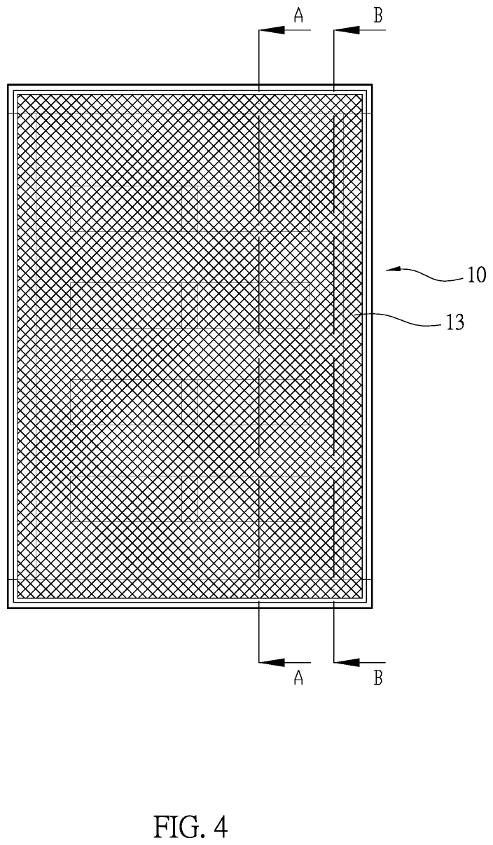

FIG. 3 of the preferred embodiment according to the present invention.

FIG. 7 shows a cross-sectional view of completely closed state along line A-A and B-B in FIG. 3 of the preferred embodiment according to the present invention.

### DETAILED DESCRIPTION OF THE PREFERRED EMBODIMENT

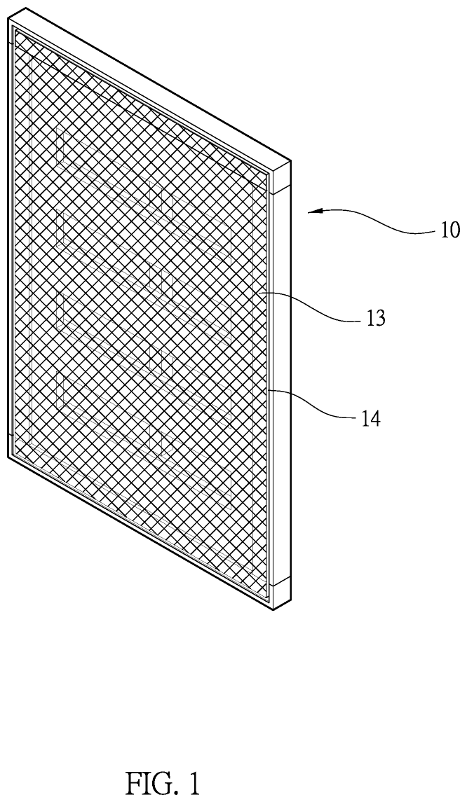

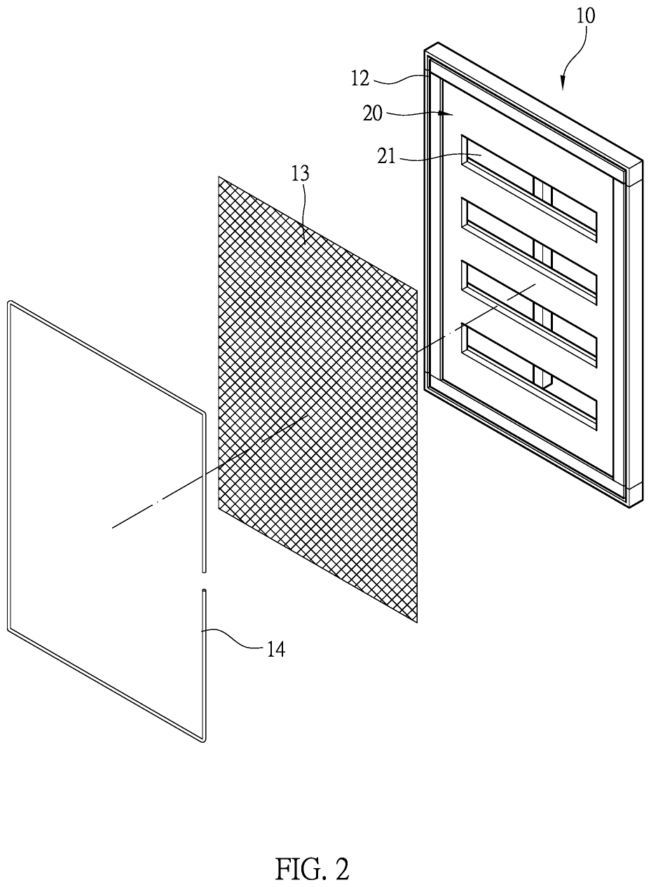

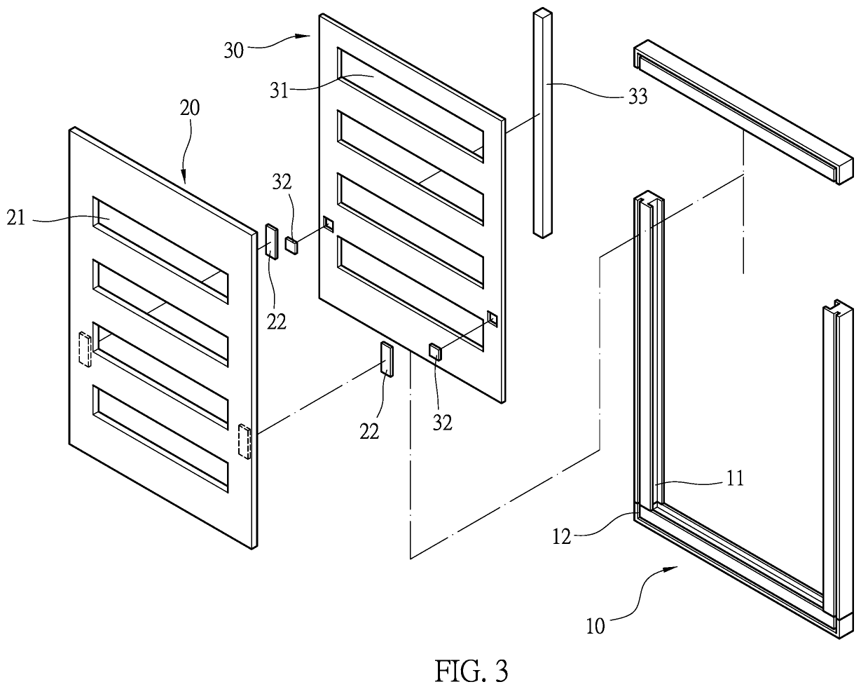

First, please refer to FIG. 1 and FIG. 2. A shutter with a dimming capability comprising: a frame member 10, a first shutter body 20, and a second shutter body 30. The frame member 10 further comprises a sliding slot 11, and a width of the sliding slot 11 is larger than a thickness of the first and second shutter bodies 20, 30. The first shutter body 20 has a plurality of through apertures 21 on a surface and at least one magnetic member 22 disposed along two sides of the through apertures 21. A height of the second shutter body 30 is shorter than a height of the first shutter body 20, and the second shutter body 30 further comprises a plurality horizontal channels 131 on a surface and at least one magnet member 32 disposed along the horizontal channels 31. An area of the magnet member 32 is smaller than an area of the magnetic member 22. A length of the magnetic member 22is greater than or equal to a height difference between the second shutter body 30 and the first shutter body 20. Furthermore, an outer surface the second shutter body 30 further comprises a control handle 33.

For structural assembly, please refer to FIG. 3. The first and second shutter bodies 20, 30 are combinable via the magnetic member 22 and the magnet member 32. When a bottom of the second shutter body 30 and a bottom of the first shutter body 30 are aligned, the horizontal channels 31 of the second shutter body 30 and the through apertures 21 of the first shutter body 20 are connected. Therefore, the first and second shutter body 20, 30 are silbably mounted in the sliding slot 11 of the frame member 10, and the second shutter body 30 is able to slide along the sliding slot 11 of the frame member 10.

Moreover, an outer side of the frame member 10 further comprises a surrounding engaging groove 12 for accepting a screen net 13. An area of the screen net 13 is larger than an area of the engaging groove 12, and a pressing strip 14 is employed to press and secure the screen net 13 into the engaging groove 12.

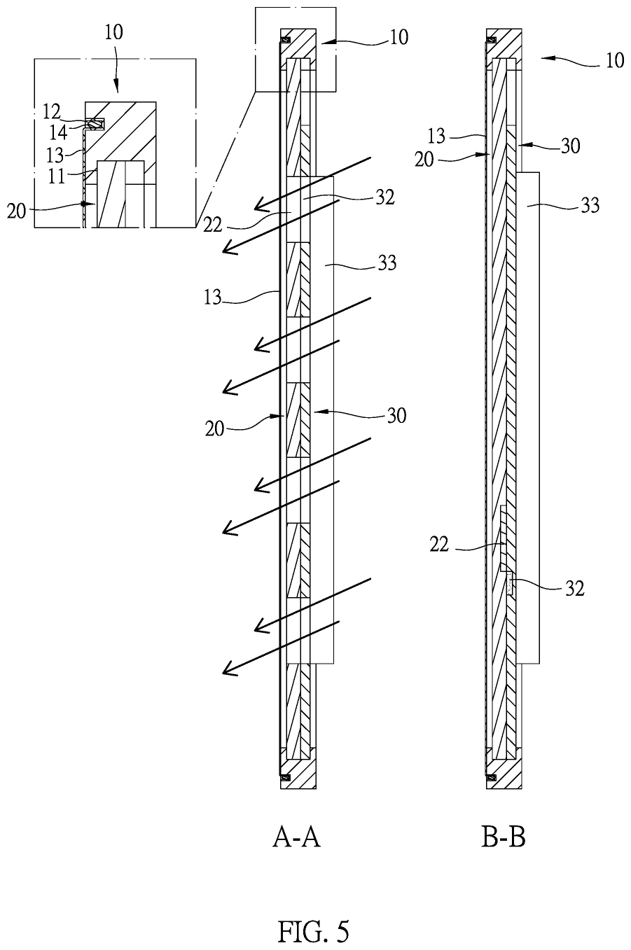

The actual use of the structure is shown in FIGS. 3-5. Since the height of the second shutter body 30 is less than the height of the first shutter body 20, the first shutter body 20 is restricted by the frame member 10 and the second shutter body 30 is able to slide in the sliding slot 11 of the frame member 10 due to the height difference. Therefore, when the bottom of the second shutter body 30 is aligned with the first shutter body 20, the horizontal channels 31 on the surface of the second shutter body 30 are connected with the through apertures 21 of the first shutter body 20, so that the through apertures 21 of the first shutter body 20 is allowing maximum light to pass through.

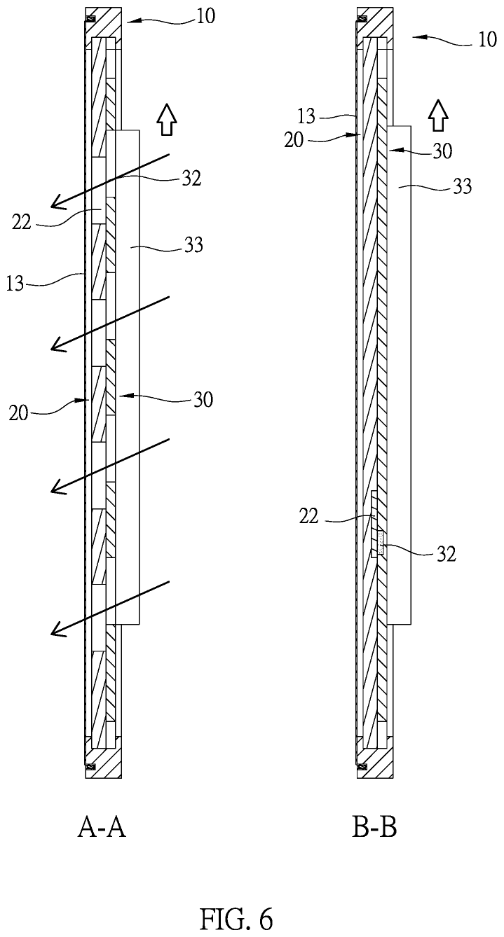

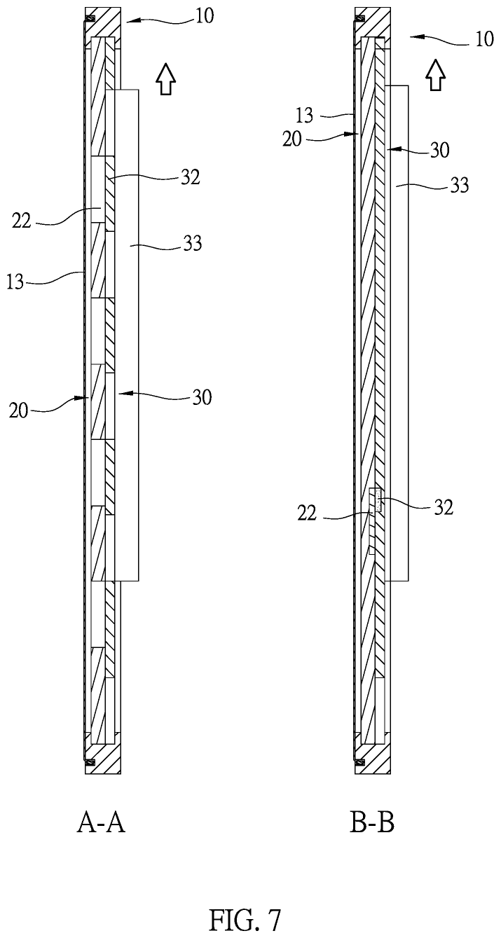

Secondly, in order to adjust the light passing through the through aperture 21 of the first shutter body 20, please refer to FIGS. 6 and 7, the second shutter body 30 is moved up along the sliding slot 11 so that the horizontal channels 31 of the second shutter body 30 is gradually apart from the through apertures 21 of the first shutter body 20, so that the portion of the second shutter body 30 that are not the horizontal channels 31 is covering the through apertures 21 to block light. After the second shutter body 30 slides, since the magnet member 32 is smaller than the magnetic member 22, with the movement of the magnetic member 22, the second shutter body 30 and the first shutter body 20 remain securely attached for adjusting the amount of light transmission.

Furthermore, in order to completely block the light through the through apertures 21, please refer to FIG. 7 again, the second shutter body 30 is moved to the top of the sliding slot 11 so that the top of the second shutter body 30 is alinged with the top of the first shutter body 30, and the horizontal channels 31 of the second shutter body 30 and the through apertures 21 of the first shutter body 20 can be completely apart from each other to form a completely shaded state.

By the structure of the above specific embodiments, the following benefits can be obtained: the shutter with dimming capability is easy to install in various frames, such as window frames or skylight opening designs, and multiple shutter panels can be assembled to form a foldable screen unit or the surrounding cover structure for various structures with light adjustment abilities. The second shutter body 30 is capable of sliding in the frame member 10, allowing the through apertures 21 and the horizontal channels 31 of the first and second shutter body 20, 30 are connected and staggered, so as to achieve the adjustment of light transmission, which helps to improve the convenience and practicality of the structure.

In addition, the first and second shutter body 20 and 30 employ the attractive force of the magnetic member 22 and the magnet member 32 to make the second shutter body 20 to slide smoothly, which also improves the convenience and practicality.

Although the present invention has been explained in relation to its preferred embodiment, it is to be understood that many other possible modifications and variations can be made without departing from the spirit and scope of invention as hereinafter claimed.

What is claimed is:

1. A shutter with a dimming capability comprising: a frame member, a first shutter body, and a second shutter body; the first shutter body having a plurality of through apertures on a surface and at least one magnetic member disposed along two sides of the through apertures; a height of the second shutter body being shorter than a height of the first shutter body, and the second shutter body further comprising a plurality of horizontal channels on a surface and at least one magnet member disposed along the horizontal channels; an area of the magnet member being smaller than an area of the magnetic member; wherein the first and second shutter bodies are combinable via the magnetic member and the magnet member and slidably mounted in the frame member such that the second shutter body is movable in the frame member.

2. The shutter with a dimming capability as claimed in claim 1, wherein the frame member further comprises a sliding slot, and a width of the sliding slot is larger than a thickness of the first and second shutter bodies.

3. The shutter with a dimming capability as claimed in claim 1, wherein a bottom of the second shutter body and a bottom of the first shutter body are aligned, and the horizontal channels of the second shutter body and the through apertures of the first shutter body are connected.

4. The shutter with a dimming capability as claimed in claim 1, wherein a length of the magnetic member is greater than or equal to a height difference between the second shutter body and the first shutter body.

5. The shutter with a dimming capability as claimed in claim 1, wherein an outer surface the second shutter body further comprises a control handle.

6. The shutter with a dimming capability as claimed in claim 1, wherein an outer side of the frame member further comprises a screen net.

7. The shutter with a dimming capability as claimed in claim 6, wherein an outer side of the frame member further comprises a surrounding engaging groove, an area of the screen net being larger than an area of the engaging groove, and a pressing strip is employed to press and secure the screen net into the engaging groove.
